(19) United States
(12) Patent Application Publication
(10) Pub. No.: US 2018/0086114 A1
(43) Pub. Date: Mar. 29, 2018

(54) PRINTING APPARATUS AND PRINTING METHOD

(71) Applicant: FUJIFILM Corporation, Tokyo (JP)

(72) Inventor: Yosuke KIMURA, Kanagawa (JP)

(73) Assignee: FUJIFILM Corporation, Tokyo (JP)

(21) Appl. No.: 15/715,171

(22) Filed: Sep. 26, 2017

(30) Foreign Application Priority Data
Sep. 28, 2016 (JP) 2016-189701

(51) Int. Cl. B41J 11/00; B41J 29/393

(52) U.S. Cl. CPC B41J 11/0085; B41J 29/393

(57) ABSTRACT

A printing apparatus and a printing method that allow transport performance, and reading and correction performance to be compatible with each other are provided. The above problem is solved by a printing apparatus including a suction unit that suctions a recording medium with a first suction force on a supporting surface; a correction unit that corrects at least one of a printing unit or a reading unit on the basis of a reading result of the reading unit; and a controller that controls a suction force of the suction unit at a reading position of the reading unit and that suctions the recording medium on the suction unit with a second suction force smaller than the first suction force or stops suction of the suction unit, at least in a case where the reading unit reads an image using a reading result in the correction unit.

### CROSS-REFERENCE TO RELATED APPLICATIONS

The present application claims priority under 35 U.S.C. § 119 to Japanese Patent Application No. 2016-189701, filed on Sep. 28, 2016. The above application is hereby expressly incorporated by reference, in its entirety, into the present application.

### BACKGROUND OF THE INVENTION

### 1. Field of the Invention

The present invention relates to a printing apparatus and a printing method, and particularly, to a printing apparatus and a printing method that suctions and transports a recording medium.

### 2. Description of the Related Art

In printing apparatuses, suctioning a recording medium from a back surface thereof to transport the recording medium is performed. In such printing apparatuses, a technique of changing a suction force according to the contents of processing and/or the state of the recording medium is known.

For example, JP2015-123590A discloses a device that changes suction pressure for a print medium in a case of printing and in a case of reading in order to suction the print medium according to a suction force allowing movement of the print medium in a scanning region of a reading sensor.

Additionally, JP2011-195295A discloses a device that has a plurality of suction regions capable of an electrostatic suction force provided in a suction force generation unit performing electrostatic suction and which controls an electrostatic suction force according to the state of a back surface of a print medium.

The print media in JP2015-123590A and JP2011-195295A are equivalent to a recording medium in the present specification. By suctioning and transporting the recording medium in this way, the transport performance during printing can be secured.

### SUMMARY OF THE INVENTION

In the printing apparatuses, reading an image printed on a recording medium by a printhead, obtaining the amount of correction of a printing property of the printhead from the read image data, and correcting the printhead with the obtained amount of correction are performed. However, in a case where a plurality of concave shapes and/or convex shapes are given on a supporting surface that supports the recording medium, the shapes appear on the front surface of a suctioned recording medium. Accordingly, there is a case where the read image data does not become suitable data and the amount of correction of the printing property cannot be appropriately obtained.

The invention has been made in view of such circumstances, and an object thereof is to provide a printing apparatus and a printing method that allow transport performance, and reading and correction performance to be compatible with each other.

In order to achieve the above object, one aspect of a printing apparatus is a printing apparatus comprising a supporting part that brings an opposite surface of a recording surface of a recording medium into contact with a supporting surface having shapes of at least one of a plurality of concave shapes or a plurality of convex shapes to support the recording surface; a suction unit that suctions the recording medium supported by the supporting part with a first suction force per unit area on the supporting surface; a transport unit that transports the recording medium suctioned on the supporting surface along a transport path; a printing unit that is disposed to face the transport path, prints an image based on input data on the recording surface at a printing position of the transport path; a reading unit that is disposed to face the transport path on a downstream side of the transport path with respect to the printing unit, and reads the recording surface at a reading position of the transport path; a correction unit that corrects at least one of the printing unit or the reading unit on the basis of a reading result of the reading unit; and a controller that controls a suction force per unit area of the suction unit at the reading position and that suctions the recording medium on the suction unit with a second suction force per unit area smaller than the first suction force per unit area or stops suction of the suction unit, at least in a case where the reading unit reads an image using a reading result in the correction unit.

According to this aspect, the recording medium is suctioned with the first suction force per unit area, and the recording medium is suctioned on the suction unit with the second suction force per unit area smaller than the first suction force per unit area or the suction of the suction unit is stopped, at least in a case where the reading unit reads the image using the reading result in the correction unit. Thus, the recording medium can be stably transported, and the reading result used in the correction unit is not influenced by the concave shapes and the convex shapes of the supporting surface. Hence, transport performance, and reading, and correction performance can be made compatible with each other.

It is preferable that the printing unit includes an ink jet head that applies ink to print an image on the recording surface of the recording medium, and a defect detection unit that detects a defect of the image on the basis of the reading result of the reading unit, and the controller makes the suction force per unit area of the suction unit at the reading position smaller in a region where the amount of ink to be applied to the recording surface is smaller, in a case where the reading unit reads the image using the reading result in the defect detection unit. Accordingly, the image defect can be appropriately detected without the reading result being influenced by the concave shapes and the convex shapes of the supporting surface.

It is preferable that the controller makes the suction force at the reading position smaller by advancing a timing of when the suction force per unit area of the suction unit is made smaller, as the amount of ink of the printed image becomes smaller. Accordingly, the image defect can be appropriately detected without the reading result being influenced by the concave shapes and the convex shapes of the supporting surface.

It is preferable that the supporting surface has a plurality of regions split in a direction orthogonal to a transport direction of the recording medium, and the controller controls the suction force per unit area of the suction unit in each of the plurality of regions. Accordingly, the suction force can be appropriately controlled.

It is preferable that the supporting surface has a plurality of regions split in a transport direction of the recording medium and a direction orthogonal to the transport direction of the recording medium, and the controller controls the suction force per unit area of the suction unit in each of the plurality of regions. Accordingly, the suction force can be appropriately controlled.

It is preferable that the printing apparatus according to any one of claims further comprises a display unit that displays the reading result of the reading unit in an enhanced manner; and an adjustment unit that allows a user to adjust at least one of the suction force per unit area of the suction unit at the reading position or a timing of when the suction force is made small. Accordingly, the influence caused by the concave shapes and the convex shapes of the supporting surface in the reading result can be appropriately eliminated.

It is preferable that the suction unit includes a vacuuming unit that vacuums gas from a suction hole formed in the supporting surface to suction the recording medium. Even in the suction unit including such a suction unit, the influence caused by the concave shapes and the convex shapes of the supporting surface on the reading result can be appropriately eliminated.

It is preferable that the transport unit includes a transport drum that rotates the recording medium suctioned on an outer peripheral surface to be transported along the transport path. Additionally, it is preferable that the supporting surface includes a jacket having shapes of at least one of the plurality of concave shapes or the plurality of convex shapes. Even in such a transport unit, the influence caused by the concave shapes and the convex shapes of the supporting surface of the reading unit can be appropriately eliminated.

It is preferable that the reading unit includes a plurality of photoelectric conversion elements, and the correction unit that corrects sensitivity of the plurality of photoelectric conversion elements on the basis of the reading result of the reading unit. Accordingly, since the influence caused by the concave shapes and the convex shapes of the supporting surface on the reading result can be appropriately eliminated, the sensitivity of the plurality of photoelectric conversion elements can be appropriately corrected.

It is preferable that the printing unit prints an image by a plurality of recording elements, and the correction unit corrects input data corresponding to the recording elements on the basis of the reading result of the reading unit. Moreover, the printing unit may print an image by a plurality of recording elements, and the correction unit may correct drive conditions of the plurality of recording elements on the basis of the reading result of the reading unit. Accordingly, since the influence caused by the concave shapes and the convex shapes of the supporting surface on the reading result can be appropriately eliminated, the input data corresponding to the plurality of recording elements and/or the drive conditions of the plurality of recording elements can be appropriately corrected.

In order to achieve the above object, one aspect of a printing method is a printing method comprising a suction step of bringing an opposite surface of a recording surface of a recording medium into contact with a supporting surface having shapes of at least one of a plurality of concave shapes or a plurality of convex shapes to support the recording surface and suctioning the supported recording medium with a suction force per a first unit area on the supporting surface; a transport step of transporting the recording medium suctioned on the supporting surface along a transport path; a printing step of printing an image based on input data on the recording surface at a printing position of the transport path by a printing unit disposed to face the transport path; a reading step of reading the recording surface at a reading position of the transport path by a reading unit disposed to face the transport path on a downstream side of the transport path with respect to the printing unit; a correction step of correcting at least one of the printing unit or the reading unit on the basis of a reading result of the reading step; and a control step of controlling a suction force per unit area of the suction step at the reading position and suctioning the recording medium in the suction step with a suction force per a second unit area smaller than the suction force per the first unit area or stopping suction of the suction step, at least in a case where an image using a reading result in the correction step is read in the reading step.

According to this aspect, the recording medium is suctioned with the first suction force per unit area, and the recording medium is suctioned on the suction unit with the second suction force per unit area smaller than the first suction force per unit area or the suction of the suction unit is stopped, at least in a case where the reading unit reads the image using the reading result in the correction unit. Thus, the recording medium can be stably transported, and the reading result used in the correction unit is not influenced by the concave shapes and the convex shapes of the supporting surface. Hence, transport performance, and reading, and correction performance can be made compatible with each other.

According to the invention, transport performance, and reading, and correction performance can be made compatible with each other.

### BRIEF DESCRIPTION OF THE DRAWINGS

FIG. 1 is a schematic view illustrating an overall configuration of an ink jet printing apparatus.

FIG. 2 is a view of an ink jet head as seen from a nozzle surface side.

FIG. 3 is a partially enlarged view of FIG. 2.

FIG. 4 is a perspective view illustrating an overall structure of a transport drum.

FIG. 5 is an exploded perspective view illustrating an internal structure of the transport drum.

FIG. 6 is a view illustrating a front surface of a ceramic jacket.

FIG. 7 is a 7-7 sectional view of FIG. 6.

FIG. 8 is a schematic view illustrating absorption of elastic deformation of paper.

FIG. 9 is a block diagram illustrating an electrical configuration of the ink jet printing apparatus.

FIG. 10 is a view illustrating a plurality of split regions of a transport surface of the transport drum.

FIG. 11 is a flowchart illustrating steps of a printing method.

FIG. 12 is a view illustrating a state in which paper is fed from a paper feed unit to a transport unit.

FIG. 13 is a view illustrating a state in which a leading end side of paper to be transported has reached a printing position.

FIG. 14 is a view illustrating a state in which a region A₁ has reached a reading position.

FIG. 15 is a view illustrating a state in which regions A₂ and A₃ have reached the reading position.

FIG. 16 is a timing chart illustrating changes in a PageSync signal and changes in the suction pressures of respective regions A₁, A₂, A₃, A₄, and A₅.

FIG. 17 is read image data of a density unevenness correction test chart.

FIG. 18 is read image data of a density unevenness correction test chart.

FIG. 19 is a block diagram illustrating an electrical configuration of an ink jet printing apparatus.

FIG. 20 is a view illustrating a transport surface of a transport drum.

FIG. 21 is a flowchart illustrating steps of a printing method.

FIG. 22 is a view illustrating an example of an image printed on paper.

FIG. 23 is a view illustrating suction pressures of respective regions of the transport surface.

FIG. 24 is a flowchart illustrating steps of a printing method.

FIG. 25 is a schematic view illustrating an overall configuration of an ink jet printing apparatus.

### DESCRIPTION OF THE PREFERRED EMBODIMENTS

Preferred embodiments of the invention will be described below in detail according to the accompanying drawings.

### <Overall Configuration of Ink Jet Printing Apparatus>

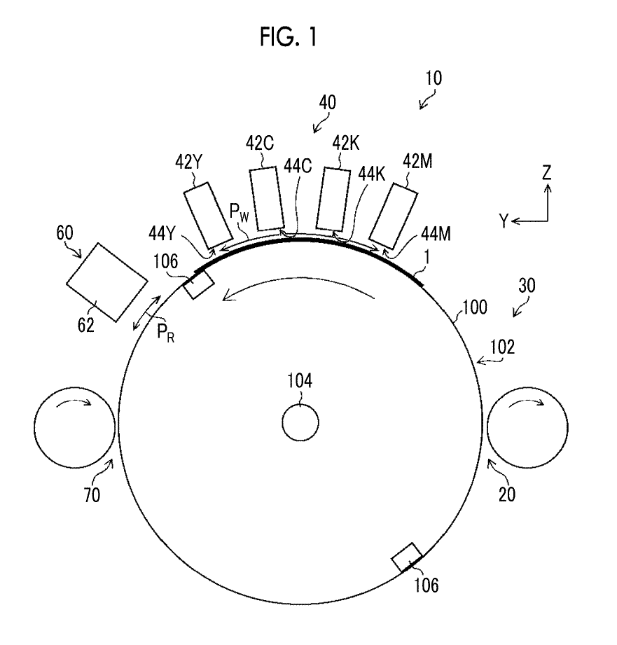

FIG. 1 is a schematic view illustrating an overall configuration of an ink jet printing apparatus 10 related to the present embodiment. As illustrated in this drawing, the ink jet printing apparatus 10 is a single path type line printer that prints an image on a recording surface of paper 1 (an example of a recording medium), and includes a paper feed unit 20, a transport unit 30, a printing unit 40, a reading unit 60, a paper ejection unit 70, and the like.

The transport unit 30 includes a transport drum 100. The transport drum 100 has a transport surface 102 (an example of a supporting surface) and a rotary shaft 104 that holds the paper 1. Additionally, two grippers 106 for gripping a leading end of the paper 1 are provided at positions that face each other with the rotary shaft 104 of the transport surface 102 interposed therebetween.

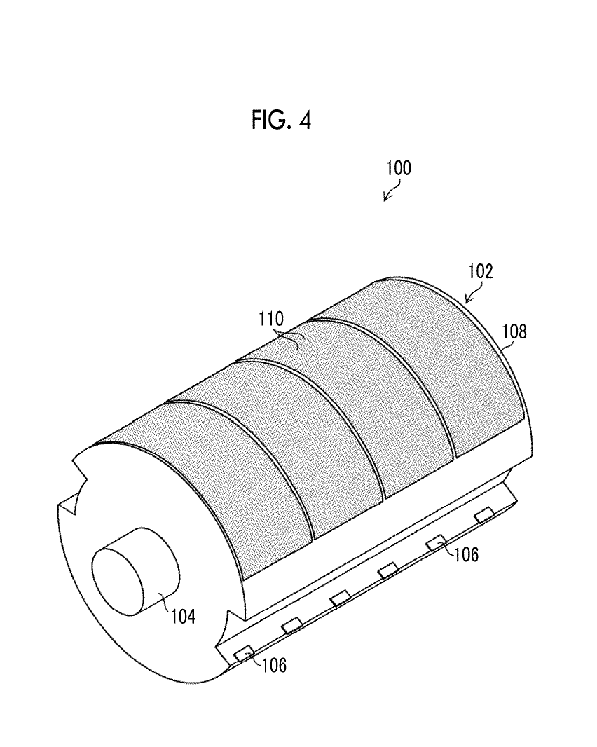

Additionally, a large number of suction holes 110 (refer to FIG. 4) is formed in a fixed pattern on the transport surface of the transport drum 100. The paper 1 introduced from the paper feed unit 20 has its leading end gripped by the grippers 106 and is wound around the transport surface 102 of the transport drum 100 that is rotating. Moreover, by vacuuming the paper 1 from suction holes 110, a surface opposite to the recording surface is suctioned on and held by the transport surface 102 of the transport drum 100. The transport drum 100 holds the paper 1 on the transport surface 102 and rotates in the counterclockwise direction in FIG. 1 around the rotary shaft 104, thereby transporting the paper 1 along a transport path. The paper 1, which has passed through a printing position P_{W} that is a position on a transport path which faces the printing unit 40 and a reading position P_{R} that is a position that faces the reading unit 60, is discharged from the paper ejection unit 70. Since the transport drum 100 includes the grippers 106 in the two positions, the transport drum 100 can transport two sheets of the paper 1 in one rotation.

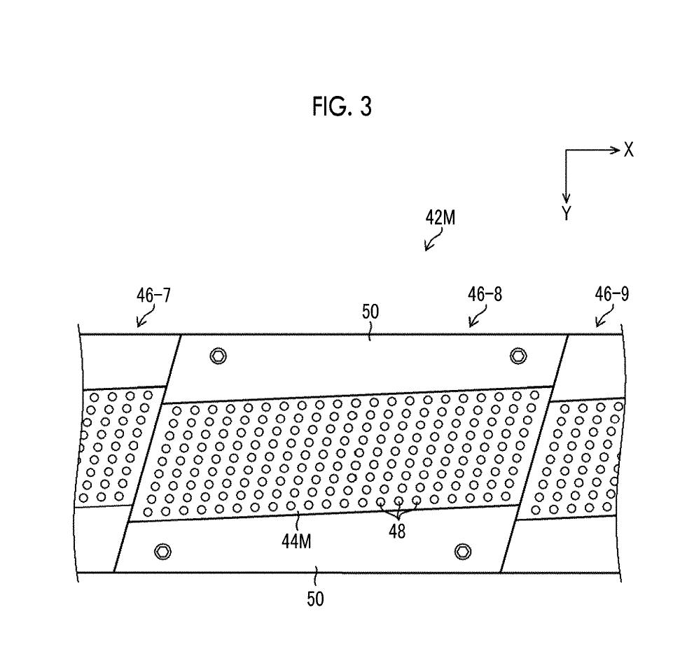

The printing unit 40 includes four ink jet heads 42M, 42K, 42C, and 42Y, and the ink jet heads 42M, 42K, 42C, and 42Y are respectively disposed sequentially from an upstream side at regular intervals along the transport path of the paper 1 on the transport drum 100. Additionally, the ink jet heads 42M, 42K, 42C, and 42Y respectively include nozzle surfaces 44M, 44K, 44C, and 44Y that face the transport drum 100, and a plurality of nozzles 48 (refer to FIG. 3) for discharging magenta ink (M ink), black ink (K ink), cyan ink (C ink), and yellow ink (Y ink) respectively are formed over the full width of the paper 1 in the respective nozzle surfaces 44M, 44K, 44C, and 44Y.

The respective ink jet heads 42M, 42K, 42C, and 42Y are held such that the respective nozzle surfaces 44M, 44K, 44C, and 44Y become parallel to tangential directions of positions that face the respective nozzle surfaces 44M, 44K, 44C, and 44Y of the transport surface of the transport drum 100.

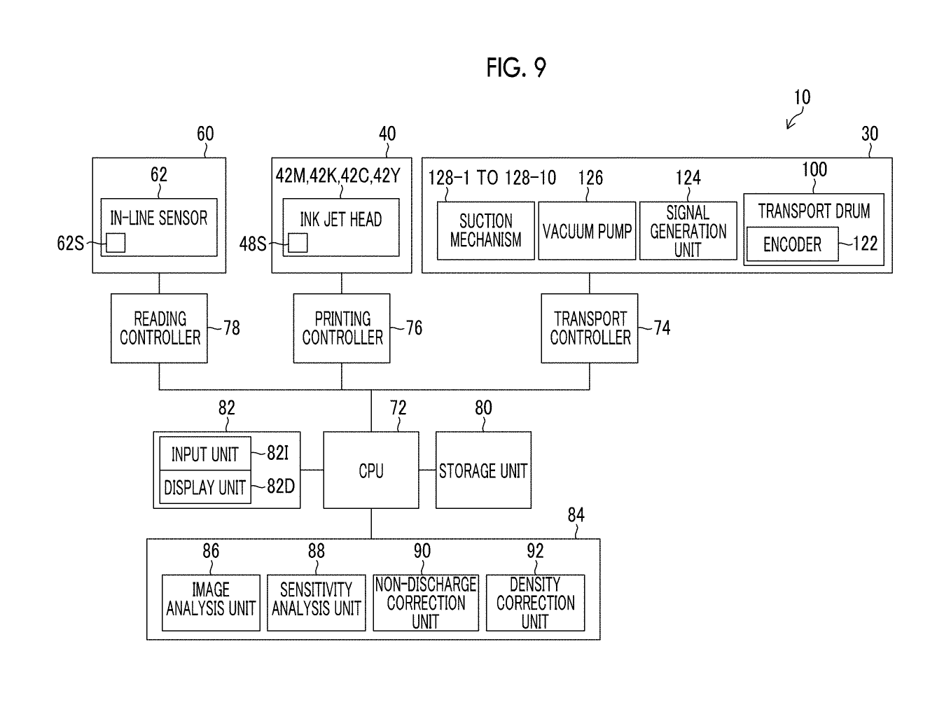

Through the control of a printing controller 76 (refer to FIG. 9) that generally controls printing of the ink jet printing apparatus 10, the ink jet heads 42M, 42K, 42C, and 42Y discharge ink from the respective nozzles 48 on the basis of input image data (an example of input data) and prints an image on the recording surface of the paper 1 transported on the transport drum 100.

The reading unit 60 is disposed on a downstream side of the printing unit 40 on the transport path of the transport drum 100. The reading unit 60 includes an in-line sensor 62.

A plurality of photoelectric conversion elements 62S (refer to FIG. 9) capable of reading a length corresponding to the full width of the paper 1 are disposed in the in-line sensor 62. The in-line sensor 62 irradiates the recording surface of the paper 1 with light in a case where the paper 1 passes through the reading position P_{R}, reads an image recorded on the recording surface of the paper 1 from reflected light, and converts the image into read image data.

In addition, the distance in a transport direction between the printing unit 40 and the reading unit 60 is shorter than the length of the paper 1 in its transport direction. Hence, the paper 1 during transport may straddle both of the printing position P_{W} and the reading position P_{R}.

### <Configuration of Ink Jet Head>

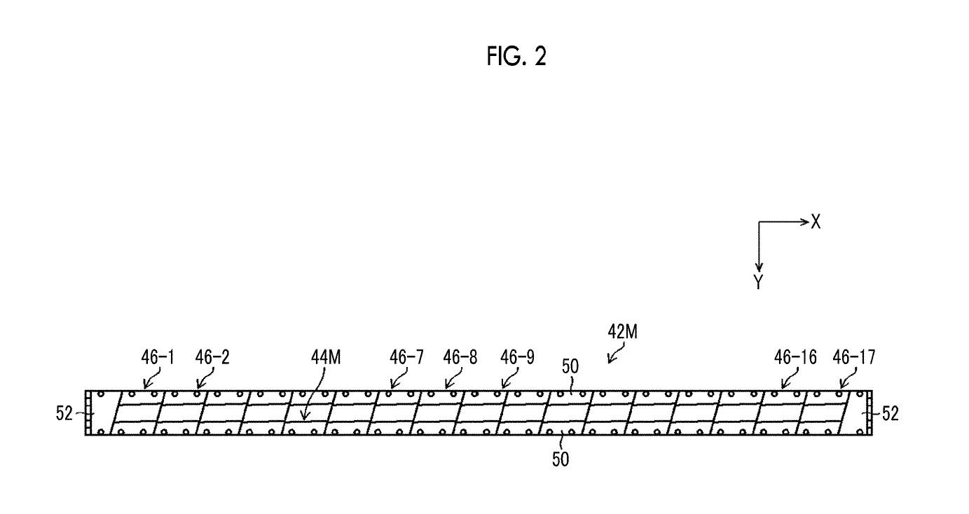

Since the ink jet heads 42M, 42K, 42C, and 42Y have the same configuration, the ink jet head 42M will be representatively described herein. FIG. 2 is a view of the ink jet head 42M as seen from the nozzle surface 44M side, and FIG. 3 is a partially enlarged view of FIG. 2.

The ink jet head 42M has an elongated structure in which seventeen head modules 46-1 to 46-17 are connected together in an X direction, and a plurality of nozzles 48 are disposed in two dimensions over a length corresponding to the full width of the paper 1 on the nozzle surface 44M. Each of the plurality of nozzles 48 includes a piezoelectric actuator 48S (refer to an example of a recording element, and FIG. 9) as a droplet discharge element, and ink is discharged from each nozzle 48 by driving the piezoelectric actuator 48S. In addition, a thermal jet method or the like may be used as a method of discharging ink from the nozzle 48.

The respective head modules 46-1 to 46-17 are configured in a replaceable manner, and are supported by a head module supporting member 50 from both sides of the ink jet head 42M in its lateral direction. Additionally, both end parts of the ink jet head 42M in its longitudinal direction are supported by a head supporting member 52.

### <Configuration of Transport Drum>

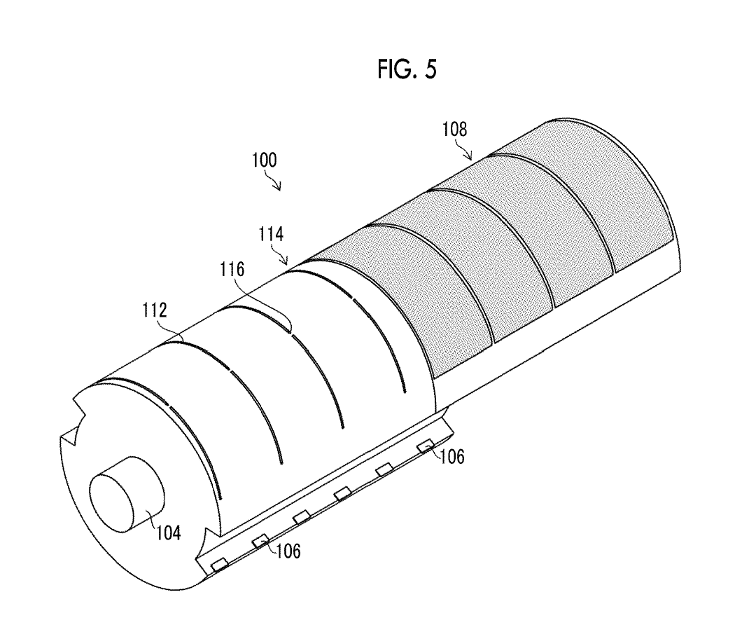

FIG. 4 is a perspective view illustrating an overall structure of the transport drum 100, and FIG. 5 is an exploded perspective view illustrating an internal structure of the transport drum 100.

The transport drum 100 includes a ceramic jacket 108 in which a large number of suction holes 110 are formed on a front surface constituting the transport surface 102, and a main drum body 114 including a drum suction groove 112, and is configured such that the ceramic jacket 108 is mounted on the main drum body 114.

A drum suction hole 116 that communicates with a vacuum flow passage (not illustrated) provided inside the main drum body 114 is provided at an end part of the drum suction groove 112 provided on a peripheral surface of the main drum body 114.

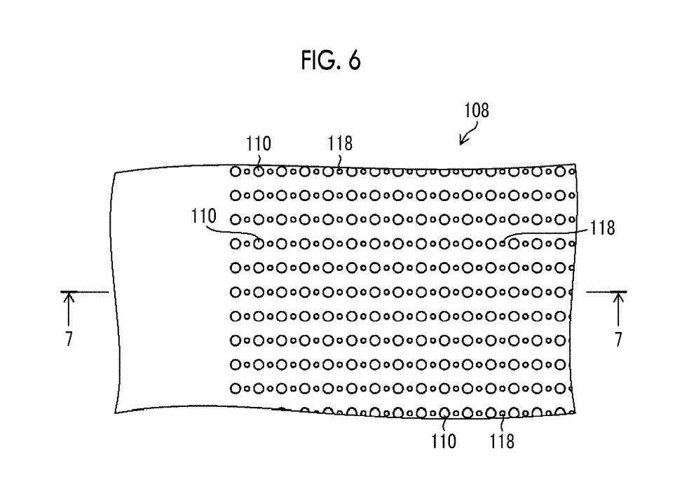

FIG. 6 is a view illustrating a front surface (the surface constituting the transport surface 102) of the ceramic jacket 108. As illustrated in this drawing, the large number of suction holes 110 (an example of concave shapes) and a large number of projections 118 (an example of convex shapes) are regularly disposed on the transport surface 102.

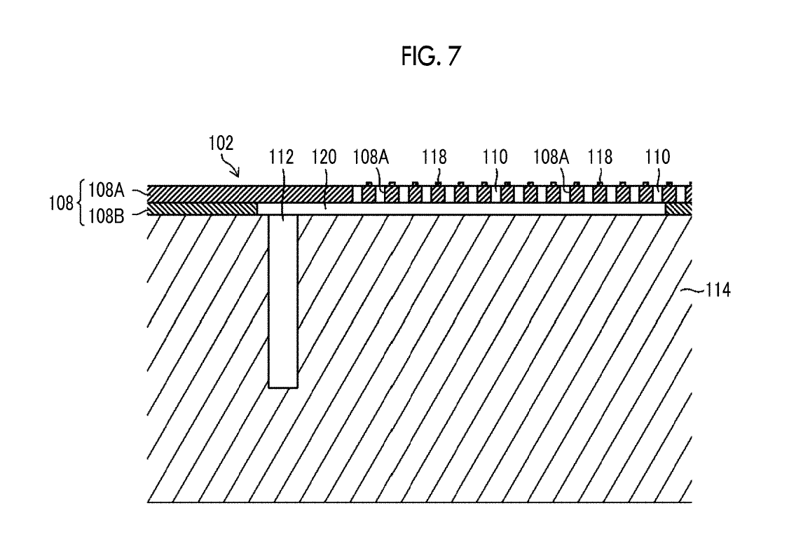

Additionally, FIG. 7 is a 7-7 sectional view of FIG. 6. The ceramic jacket 108 is constituted of a suction hole layer 108A on the front surface side which constitutes the transport surface 102 of the transport drum 100, and a flow passage groove formation layer 108B on a back surface side which comes into contact with the main drum body 114. The larger number of suction holes 110, which pass through the suction hole layer 108A in a circular shape, are formed in the suction hole layer 108A, and the columnar projections 118 are formed on the transport surface 102 side of a portion where the suction holes 110 are not formed.

Additionally, a jacket suction groove 120 is formed by the flow passage groove formation layer 108B. The jacket suction groove 120 allows the drum suction groove 112 and each suction hole 110 to communicate with each other.

In addition, although the ceramic jacket 108 in which the large number of suction holes 110 and the large number of projections 118 are formed is mounted on the main drum body 114, the large number of suction holes 110 and the large number of projections 118 may be formed in the main drum body 114 without using the ceramic jacket 108.

Additionally, the suction holes 110 are not limited to those passing through the suction hole layer in a circular shape, and may pass through the suction hole layer in a quadrangular shape or a polygonal shape. Additionally, the shape of the projections 118 is not limited to the columnar shape, and may be a semi-spherical shape (a dome shape), a quadrangular prismatic shape, and a polygonal prismatic shape.

If a vacuum pump 126 (refer to FIG. 9) that communicates with the vacuum flow passage (not illustrated) is driven, the suction pressure for suctioning and holding the paper 1 is generated in the suction holes 110 via the drum suction groove 112 and the jacket suction groove 120.

### <Problems of Reading in Reading Unit>

The distance between the transport drum 100 and the ink jet heads 42M, 42K, 42C, and 42Y is about 1.0 to 2.0 mm. Hence, if floating occurs in the paper 1, printing may not be performed normally and also the ink jet heads 42M, 42K, 42C, and 42Y may be brought into contact with the paper 1 and the ink jet heads 42M, 42K, 42C, and 42Y may be broken. For this reason, the paper 1 is transported while being suctioned on the transport surface 102.

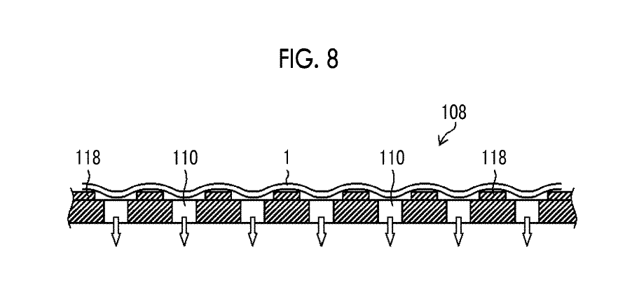

Here, for example, in a case where a back surface is already printed, the paper 1 shrinks partially, and it is difficult for the paper to be normally suctioned. Hence, in the ink jet printing apparatus 10, by disposing the suction holes 110 and the projections 118 in a certain pattern in the ceramic jacket 108 of the transport drum 100, elastic deformation of the paper 1 is absorbed, the paper is suctioned, and the transport performance is realized. FIG. 8 is a schematic view illustrating the absorption of the elastic deformation of the paper 1. By forming concavo-convex shapes in the transport surface 102 in this way, the deformation that the paper 1 has can be absorbed by the concavo-convex shapes, and the paper 1 can be brought into close contact with the transport surface 102 without generating wrinkling or floating.

However, it was found that an arrangement pattern (hereinafter simply referred to as the pattern of the ceramic jacket 108) of the suction holes 110 and projections 118 that are disposed on the ceramic jacket 108 greatly influences reading of the in-line sensor 62. That is, as the absorption amount of the deformation of the paper 1 increases, the radiation angle of light to a portion that is being deformed varies, and reading cannot be performed normally. Moreover, an influence such that the pattern of the ceramic jacket 108 is visible through the paper 1 is also added, and the reading unevenness corresponding to the pattern of the ceramic jacket 108 occurs. An abnormal value is output if correction of the printing unit or detection of an image defect is performed using the read image data in which this unevenness has occurred. Due to this problem, the pattern of the ceramic jacket 108 cannot be optimized for the transportability of the paper 1.

### First Embodiment

FIG. 9 is a block diagram illustrating an electrical configuration of the ink jet printing apparatus 10. As illustrated in this drawing, the ink jet printing apparatus 10 includes a central processing unit (CPU) 72, a transport controller 74, the printing controller 76, a reading controller 78, a storage unit 80, a user interface 82, an image processing unit 84, and the like in addition to the aforementioned transport unit 30, printing unit 40, and reading unit 60.

The transport unit 30 includes the transport drum 100, a rotary encoder 122, a signal generation unit 124, the vacuum pump 126, and suction mechanisms 128-1 to 128-10.

The rotary encoder 122 outputs an encoding signal according to the rotational angle of the transport drum 100. The signal generation unit 124 generates and outputs a PageSync signal that is a printing timing signal in which a timing of when the paper 1 passes through the printing position P_{W} is defined as L(0) level and the other timings are defined as H(1) level, on the basis of the encoding signal of the rotary encoder 122.

The vacuum pump 126 (an example of a vacuuming unit) is a pump that vacuums and evacuates the inside of the vacuum flow passage (not illustrated) of the transport drum 100.

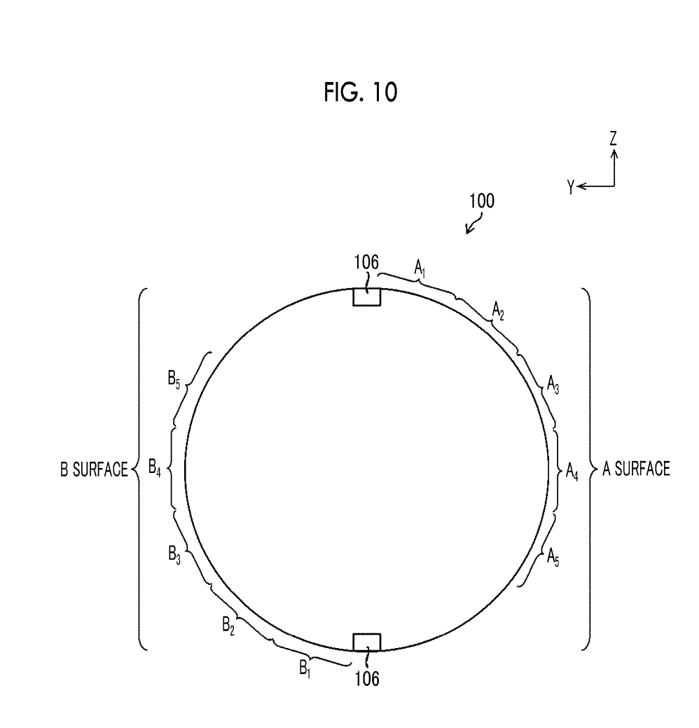

The suction mechanisms 128-1 to 128-10 (an example of a suction unit) controls the suction pressure (an example of a suction force per unit area) of the suction holes 110 on the transport surface 102. As mentioned above, the transport drum 100 can transport two sheets of the paper 1 in one rotation. As illustrated in FIG. 10, the transport surface 102 of the transport drum 100 has an A surface side and a B surface side that transports the paper 1, respectively. Additionally, the A surface side has a plurality of regions A₁, A₂, A₃, A₄, and A₅ that are split in one dimension in a direction orthogonal to the transport direction of the paper 1. Similarly, the B surface side of the transport surface 102 has a plurality of regions B₁, B₂, B₃, B₄, and B₅ that are split in one dimension in the direction orthogonal to the transport direction of the paper 1.

The suction mechanisms 128-1 to 128-10 correspond to the regions A₁, A₂, A₃, A₄, A₅, B₁, B₂, B₃, B₄, and B₅, respectively, and are configured to be capable of controlling the suction pressure of the suction holes 110 in each region. For example, by providing a valve (not illustrated) in each of the paths between the vacuum pump 126 and the vacuum flow passage (not illustrated), the drum suction holes 116, and the suction holes 110 in each region and by controlling this valve, the suction pressure of the suction holes 110 in each region can be controlled.

Returning to the description of FIG. 9, the CPU 72 generally controls the respective parts of the ink jet printing apparatus 10.

The transport controller 74 controls the rotation of the transport drum 100 and the evacuation of the vacuum pump 126. Additionally, the transport controller 74 controls the Suction mechanisms 128-1 to 128-10 provided corresponding to the respective regions, respectively, thereby controlling the suction pressure of the suction holes 110 of the transport drum 100 in each region of the transport surface 102, and controlling the suction pressure at least at the reading position P_{R}.

The printing controller 76 controls the ink jet heads 42M, 42K, 42C, and 42Y of the printing unit 40 on the basis of the image data stored in the storage unit 80, and causes an image to be printed on the paper 1. The reading controller 78 controls the in-line sensor 62 of the reading unit 60, and causes an image recorded on the recording surface of the paper 1 to be read.

The image data for performing printing on the paper 1 is stored in the storage unit 80. Additionally, the read image data acquired by the in-line sensor 62 is stored.

The user interface 82 includes an input unit 82I and a display unit 82D that allow a user to operate the ink jet printing apparatus 10. In the present embodiment, a touch panel, which is constituted of the display unit 82D serving as a display that displays image data and various kinds of information, and an input unit 82I serving as a control panel of which the whole surface is transparent and is superposed on the display and which receives the input from a user, is used. The user can operate the user interface 82, thereby causing the ink jet printing apparatus 10 to print a desired image.

The image processing unit 84 includes an image analysis unit 86, a sensitivity correction unit 88, a non-discharge correction unit 90, and a density correction unit 92. The image analysis unit 86 analyzes the read image data acquired from the in-line sensor 62.

The sensitivity correction unit 88 corrects the sensitivity of the photoelectric conversion elements 62S of the in-line sensor 62 on the basis of analysis results of the image analysis unit 86.

The non-discharge correction unit 90 identifies a defective nozzle that is a nozzle 48 with abnormal discharge of ink, such as bending or non-discharge, from the ink jet heads 42M, 42K, 42C, and 42Y, on the basis of the analysis results of the image analysis unit 86, stops the discharge from the defective nozzle, and corrects the printing unit 40 by correcting input image data so as to perform printing using a nozzle 48, serving as an alternative nozzle, adjacent to the defective nozzle.

The density correction unit 92 acquires variations in density regarding the respective nozzles 48 of the ink jet heads 42M, 42K, 42C, and 42Y on the basis of the analysis results of the image analysis unit 86, and corrects the drive conditions of the piezoelectric actuator 48S in each nozzle 48.

In addition, the image processing unit 84 may not be built in the ink jet printing apparatus 10, and may be constituted as a computer (not illustrated) that is communicably connected to the ink jet printing apparatus 10. Additionally, an image for performing printing from the computer (not illustrated) may be acquired.

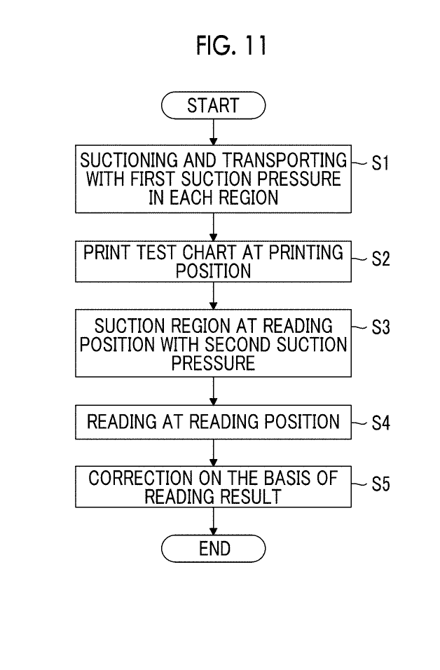

FIG. 11 is a flowchart illustrating steps of a printing method related to the first embodiment. Here, a case where a test chart is printed on the paper 1 to be transported on the A surface side of the transport surface 102 will be described.

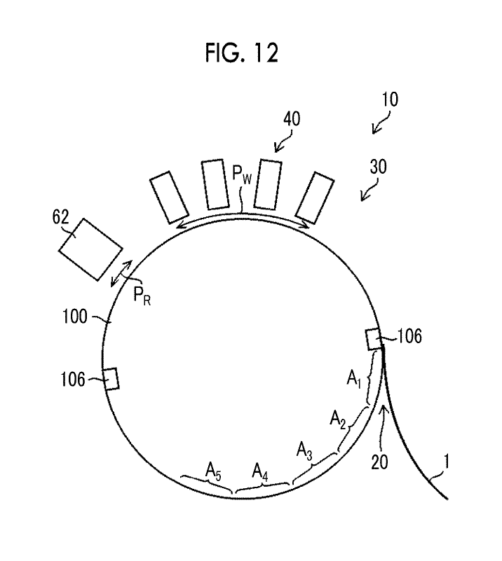

First, in the plurality of regions A₁, A₂, A₃, A₄, and A₅ on the A surface side of the transport surface 102, the paper 1 is suctioned and transported with 20 kPa that is a first suction pressure (an example of a first suction force per unit area) from the respective suction holes 110 (Step S1, an example of a suction step, an example of a transport step). FIG. 12 is a view illustrating a state in which the paper 1 is fed from the paper feed unit 20 to the transport unit 30.

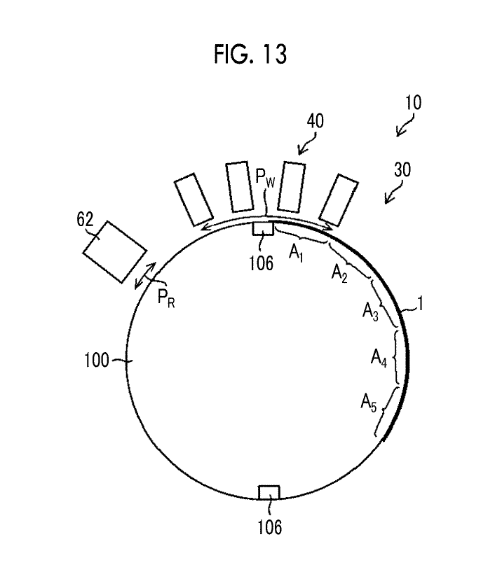

If the paper 1 reaches the printing position P_{W}, a PageSync signal is an L level. The printing unit 40 detects the L level of the PageSync signal, and prints an image on the paper 1 (Step S2, an example of a printing step). Here, a test chart for detecting non-discharge and a test chart for detecting density unevenness are printed. Since the paper 1 is suctioned and transported with a suction pressure of 20 kPa, the paper 1 can be stably transported, and a test chart can be appropriately printed. FIG. 13 is a view illustrating a state in which a leading end side of the paper 1 to be transported has reached the printing position P_{W}.

Next, in the regions A₁, A₂, A₃, A₄, and A₅, the suction pressure of the suction holes 110 at the reading position P_{R} is changed to 10 kPa that is sequentially a second suction pressure (an example of a second suction force per unit area), and the paper 1 is suctioned (Step S3, an example of a control step).

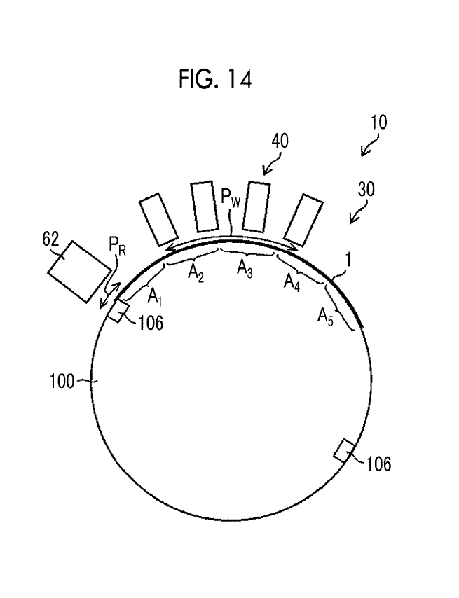

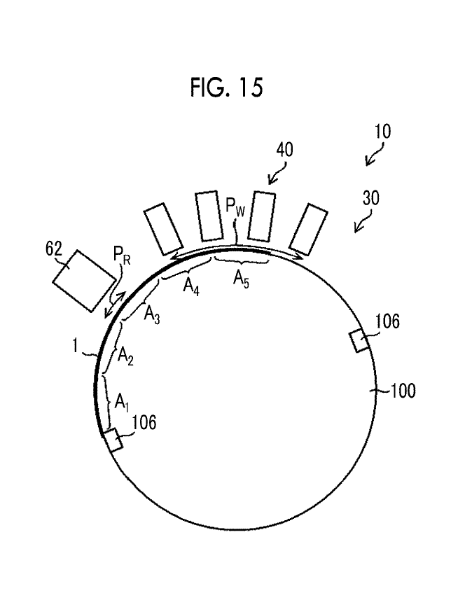

FIG. 14 is a view illustrating a state in which the region A₁ has reached the reading position P_{R}. In this state, the suction pressure of the region A₁ is set to 10 kPa, and the suction pressure of the regions A₂, A₃, A₄, and A₅ is set to 20 kPa. Additionally, FIG. 15 is a view illustrating a state in which the region A₁ of the paper 1 passed through the reading position P_{R} and the regions A₂ and A₃ have reached the reading position P_{R}. In this state, the suction pressure of the regions A₂ and A₃ is set to 10 kPa, and the suction pressure of the regions A₁, A₄, and A₅ is set to 20 kPa.

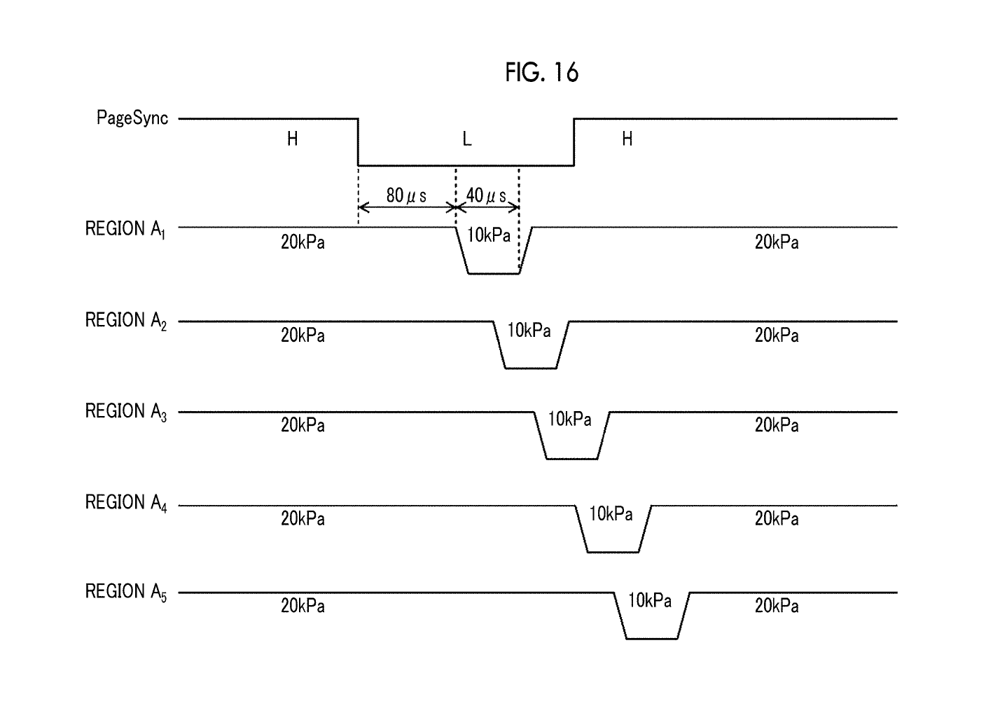

Here, the transport controller 74 controls the suction pressure using the PageSync signal that is used as a reading start trigger signal by the in-line sensor 62. FIG. 16 is a timing chart illustrating changes in the PageSync signal and changes in the suction pressures of the respective regions A₁, A₂, A₃, A₄, and A₅.

In the present embodiment, the in-line sensor 62 starts reading 100 microseconds after falling of the PageSync signal is input. Additionally, the suction mechanism 128-1 makes the suction pressure gradually smaller 80 microseconds after the falling of the PageSync signal is input. Thereafter, the suction mechanisms 128-2 to 128-5 make the suction pressure small in order.

The suction pressure is gradually changed from 20 kPa, which is a standard value in a case where the thickness of the paper 1 is less than 0.2 mm, to 10 kPa. Additionally, the suction mechanisms 128-1 to 128-5 gradually return the suction pressure to 20 kPa 40 microseconds after the suction pressure is made small.

In addition, the suction pressure may not be gradually changed but may be rapidly changed. Additionally, the suction pressure may be made small only at the reading position. Hence, the suction pressure may be changed from 20 kPa to 10 kPa 100 microseconds after the falling of the PageSync signal is input.

In this way, the transport controller 74 controls the suction mechanisms 128-1 to 128-5, thereby setting the suction pressure of a region before reaching the reading position P_{R} or after passing through the reading position P_{R} to 20 kPa that is the first suction pressure, and setting the suction pressure of a region while passing through the reading position P_{R} to 10 kPa that is the second suction pressure lower than the first suction pressure.

Then, the in-line sensor 62 reads a margin and a test chart of the paper 1 at the reading position P_{R} through the control of the reading controller 78, and converts the read margin and test chart into read image data (Step S4, an example of a reading step). At the reading position P_{R}, the paper 1 is suctioned and transported with the suction pressure of 10 kPa smaller than the suction pressure at the printing position P_{W}. Thus, the acquired read image data is not influenced by the pattern of the ceramic jacket 108.

Finally, correction of the printing unit 40 and/or the reading unit 60 is performed on the basis of a reading result of the reading unit 60 (Step S5, an example of a correction step), and the processing of a final flowchart is ended. Specifically, the sensitivity correction unit 88 corrects the sensitivity of the photoelectric conversion element 62S of the in-line sensor 62 on the basis of a reading result of the margin of the paper 1. Additionally, the non-discharge correction unit 90 corrects the input image data on the basis of a reading result of the test chart for detecting non-discharge, thereby correcting the printing unit 40. Moreover, the density correction unit 92 corrects the input image data on the basis of a reading result of the test chart for detecting density unevenness, thereby correcting the drive conditions of the piezoelectric actuator 48S provided for each nozzle 48.

Hereinafter, the same control is performed regarding the transport on the B surface side.

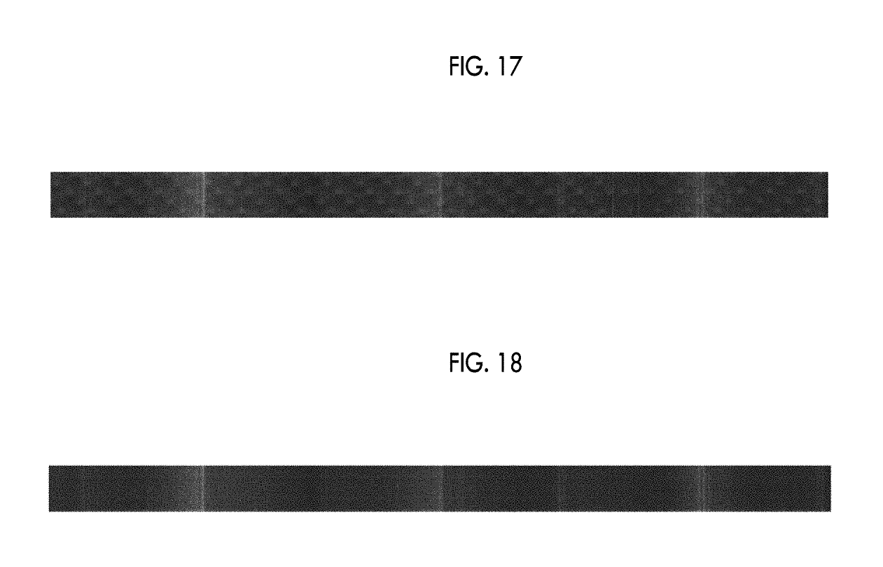

FIGS. 17 and 18 are views illustrating the read image data of an image with a uniform density in the in-line sensor 62, FIG. 17 illustrates an enhanced image in a case where the suction pressure is 20 kPa, and FIG. 18 illustrates an enhanced image in a case where the suction pressure is 10 kPa.

As illustrated in FIG. 17, in a case where the suction pressure is 20 kPa, the pattern of the ceramic jacket 108 is visually recognized in the read image data. On the other hand, as illustrated in FIG. 18, in a case where the suction pressure is 10 kPa, the pattern of the ceramic jacket 108 is not visually recognized in the read image data. In this way, by lowering the suction force per unit area at least at the reading timing of the reading unit 60, the influence caused by the pattern of the ceramic jacket 108 can be eliminated, the image recorded on the paper 1 can be appropriately read, and the reading and the correction performance during test chart printing can be ensured. Hence, the pattern of the ceramic jacket 108 can be optimized for the transportability of the paper 1, and the transport performance, and the reading and the correction performance can be made compatible with each other.

In the present embodiment, the suction pressure of a region before reaching the reading position P_{R} and after passing through the reading position P_{R} is set to the first suction pressure and the suction pressure of a region while passing through the reading position P_{R} is set to the second suction pressure lower than the first suction pressure. However, the suction pressure of a region before reaching the reading position P_{R} may be set to the first suction pressure, and the suction pressure of a region while passing through the reading position P_{R} and after the reading position P_{R} may be set to the second suction pressure lower than the first suction pressure. Additionally, an aspect in which the second suction pressure is set to zero, that is, suction is stopped is also possible.

Here, the printing for correction in which the reading unit 60 reads an image of a test chart of which a reading result is used by at least one of the sensitivity correction unit 88, the non-discharge correction unit 90, or the density correction unit 92 has been described. However, during printing, such as final printing of performing printing on printed matter to be commercially available and trial printing for final printing, the paper 1 is stably transported by performing the entire surface suction with 20 kPa that is normal suction pressure.

Additionally, the correction performed in the present embodiment is not limited to the sensitivity correction, the non-discharge correction, and the density correction, and can also be applied during correction printing of installation adjustment.

As an example of the correction printing of installation adjustment, there are reading position adjustment and non-discharge correction optimization of the in-line sensor 62.

In the reading position adjustment, the relationships between the pixel positions of the read image data of the in-line sensor 62, and the numbers (positions) of the respective nozzles 48 of ink jet heads 42M, 42K, 42C, and 42Y are calculated. By carrying out this process, the positions of the nozzles 48 can be identified from the read image data of the in-line sensor 62, and the subsequent detection or correction is possible.

Additionally, the non-discharge correction optimization is processing in which correction is performed by adjusting the discharge amount of a nozzle 48 adjacent to a defective nozzle in the non-discharge correction unit 90 in a case where the defective nozzle has occurred, but the amount of adjustment in this case is calculated in advance.

### Second Embodiment

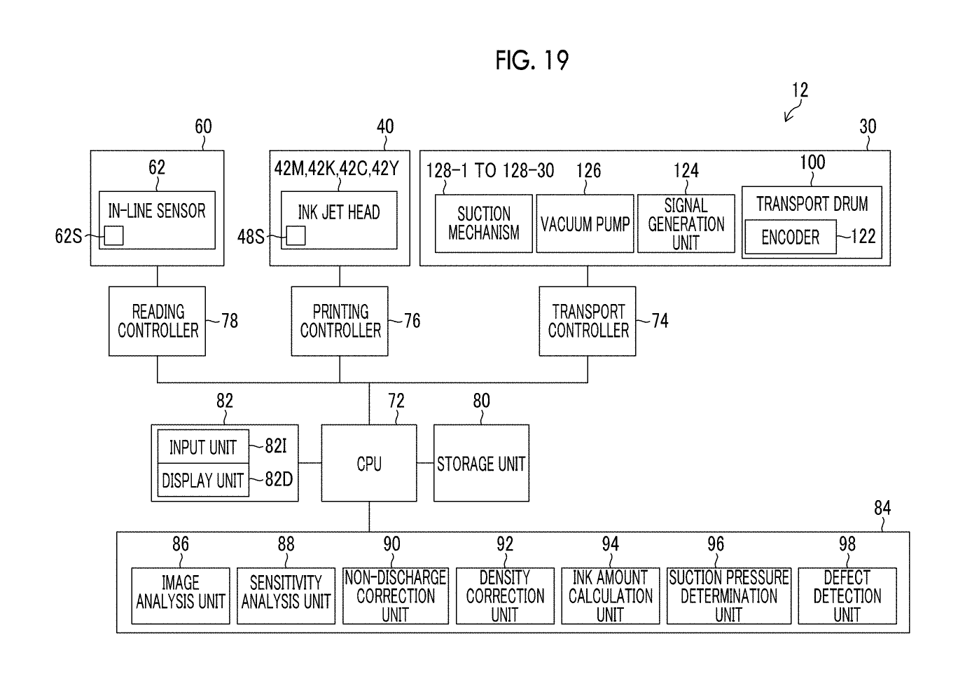

FIG. 19 is a block diagram illustrating an electrical configuration of an ink jet printing apparatus 12 related to a second embodiment. In addition, the portions that are in common with those of the block diagram illustrated in FIG. 9 will be designated by the same reference signs and the detailed description thereof will be omitted.

As illustrated in this drawing, the ink jet printing apparatus 12 includes suction mechanisms 128-1 to 128-30, an ink amount calculation unit 94, a suction pressure determination unit 96, and a defect detection unit 98.

The suction mechanisms 128-1 to 128-30 control the suction pressure of the suction holes 110 in the transport surface 102.

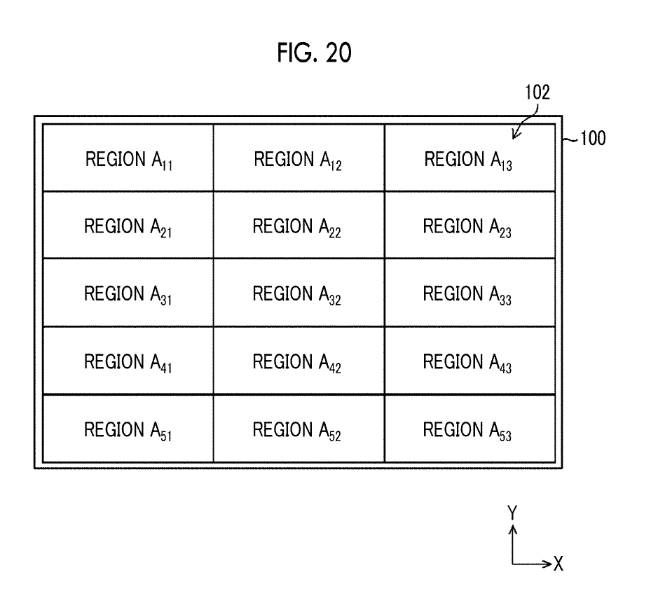

FIG. 20 is a view illustrating an A surface side of a transport surface 102 of a transport drum 100. As illustrated in this drawing, the A surface side of the transport surface 102 has a plurality of regions A₁₁, A₁₂, A₁₃, A₂₁, A₂₂, A₂₃, A₃₁, A₃₂, A₃₃, A₄₁, A₄₂, A₄₃, A₅₁, A₅₂, and A₅₃ that are two-dimensionally split into a total of 15 divisions of 3 divisions in the direction orthogonal to the transport direction of the paper 1 and 5 divisions in the transport direction of the paper 1.

The suction mechanisms 128-1 to 128-15 correspond to regions split into 15, respectively, and are configured to be capable of controlling the suction pressures of the suction holes 110 in the respective regions. Additionally, similarly, a B surface side of the transport surface 102 is also two-dimensionally split into 15 divisions and the suction mechanisms 128-16 to 128-30 correspond to regions split into 15, respectively, and are configured to be capable of controlling the suction pressure of the suction holes 110 in each region.

Returning to the description of FIG. 19, the ink amount calculation unit 94 calculates the amount of ink of an image to be printed. Here, an overall image to be printed on the paper 1 is split into a total of 15 divisions of 3 divisions in the direction orthogonal to the transport direction of the paper 1 and 5 divisions in the transport direction of the paper 1, and the amounts of ink in the respective split regions are calculated, respectively. The amount of ink in each region is the total of the amount of ink discharged from each nozzle 48 to each region in a case where printing is performed in the printing unit 40.

The suction pressure determination unit 96 determines the suction pressures in a case where the respective regions split into 15 are read in the reading unit 60 on the basis of the amounts of ink calculated in the ink amount calculation unit 94.

Additionally, the defect detection unit 98 detects a defect of a printed image on the basis of the analysis results of the image analysis unit 86. The image analysis unit 86 analyzes the printed image by comparing the read image data of the in-line sensor 62 with the image data stored in the storage unit 80.

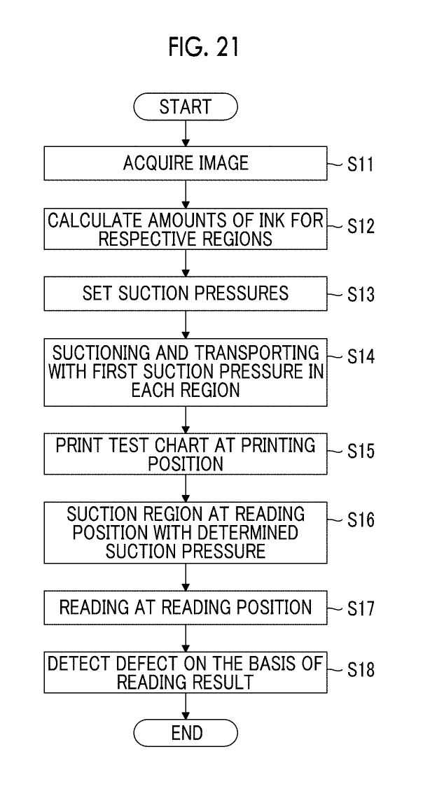

FIG. 21 is a flowchart illustrating steps of a printing method related to the second embodiment. Here, a case where an image for final printing is printed on the paper 1 to be transported on the A surface side of the transport surface 102 will be described.

First, the ink amount calculation unit 94 acquires image data for performing printing on the paper 1 from the storage unit 80 (Step S11). The image data herein is image data for final printing for the printed matter to be commercially available. Here, the ink amount calculation unit 94 calculates the amounts of ink in the respective regions split into a total of 15 divisions of 3 divisions in the direction orthogonal to the transport direction of the paper 1 and 5 divisions in the transport direction of the paper 1, respectively, regarding the acquired image data (Step S12). In addition, in a case where raster image processor (RIP) processing is performed on the image data, the amounts of ink in the respective regions may be calculated, and the calculated amounts of ink may be stored in the storage unit 80 with the image data.

Subsequently, the suction pressure determination unit 96 determines the suction pressures of the respective regions in a case of being read in the reading unit 60, on the basis of the amounts of ink calculated in Steps 12 (Step S13). Here, the amounts of ink are divided into three levels, and according to the levels, any suction pressure of 20 kPa, 15 kPa and 10 kPa is set such that the suction pressure is made lower as a region with a smaller amount of ink.

Since elongation and contraction of the paper 1 to which ink is applied becomes larger as the amount of ink is larger, it is necessary to suction the paper with a higher suction pressure in order to absorb this elastic deformation. Hence, in the ink jet printing apparatus 12, suction is performed with a higher suction pressure in a region with a relatively larger amount of ink, and suction is performed with a lower suction pressure in a region with a relatively smaller amount of ink.

In addition, the suction mechanisms 128-1 to 128-30 may determine the suction pressure in consideration of not only the amounts of ink in the respective corresponding regions but also the amounts of ink in the regions adjacent to the respective regions.

Next, in the regions split into 15 on the A surface side of the transport surface 102, the paper 1 is suctioned from the respective suction holes 110 with 20 kPa that is the first suction pressure, and transport is started (Step S14). Moreover, if the paper 1 reaches the printing position P_{W}, the printing unit 40 prints a final printing image on the paper 1 (Step S15). Since the paper 1 is suctioned and transported with a suction pressure of 20 kPa, the paper 1 can be stably transported, and an image can be appropriately printed.

Next, in the regions split into 15, the transport controller 74 changes the suction pressure of the suction holes 110 at the reading position P_{R} to the suction pressure (an example of a second suction force per unit area) determined in Step S13, and suctions the paper 1 (Step S16).

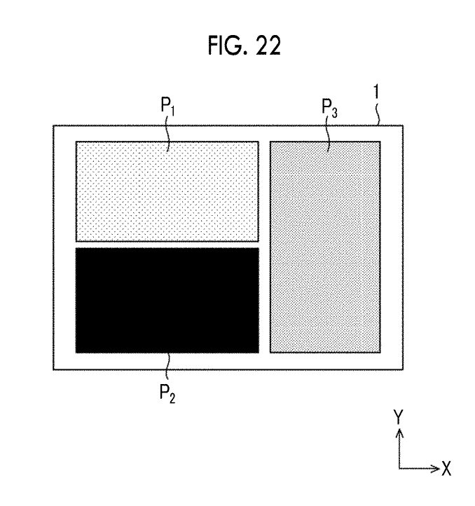

FIG. 22 is a view illustrating an example of an image printed on the paper 1. In the example illustrated in this drawing, a region P₁ where the amount of ink is relatively small, a region P₂ where the amount of ink is relatively large, and a region P₃ where the amount of ink is relatively medium are provided.

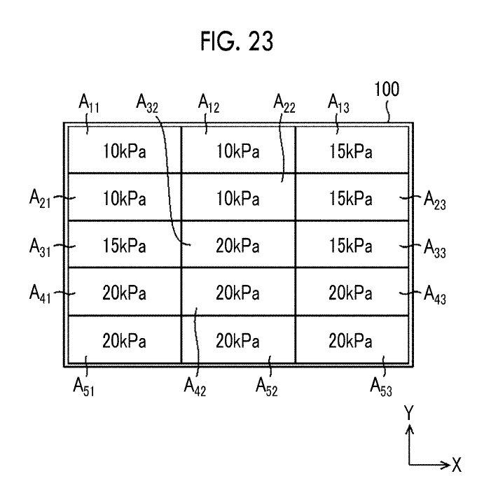

FIG. 23 is a view illustrating the suction pressures, in a case where the respective regions split into 15 on the A surface side of the transport surface 102 are read in the reading unit 60, which are determined by the suction pressure determination unit 96. As illustrated in this drawing, the suction pressures of the regions A₁₁, A₁₂, A₁₃, A₂₁, A₂₂, A₂₃, A₃₁, A₃₂, A₃₃, A₄₁, A₄₂, A₄₃, A₅₁, A₅₂, and A₅₃ are 10 kPa, 10 kPa, 15 kPa, 10 kPa, 10 kPa, 15 kPa, 15 kPa, 20 kPa, 15 kPa, 20 kPa, 20 kPa, 20 kPa, 20 kPa, 20 kPa, and 20 kPa, respectively.

The regions A₁₃, A₂₃, A₃₃, A₄₃, and A₅₃ respectively correspond to the region P₃ where the amount of ink is relatively medium, the amounts of ink are almost the same but the suction pressures are set to 15 kPa, 15 kPa, 15 kPa, 20 kPa, and 20 kPa, respectively, and not the same suction pressure. These values are different from each other depending not only on the amounts of ink in the respective regions but also on the balance between the suction pressures in the regions adjacent to the respective regions in the X direction.

Similar to the first embodiment, the transport controller 74 controls the suction pressures using a PageSync signal that is used as a reading start trigger signal by the in-line sensor 62. That is, the in-line sensor 62 starts reading 100 microseconds after falling of the PageSync signal is input, while the suction mechanisms 128-1 to 128-3 set the suction pressures of the region A₁₁, A₁₂, and A₁₃ to gradually determine suction pressures 80 microseconds after the falling of the PageSync signal is input. Moreover, the suction mechanisms 128-1 to 128-3 gradually return the suction pressures of the regions A₁₁, A₁₂, and A₁₃ to the first suction pressure 40 microseconds after the suction pressures are changed.

The suction mechanisms 128-4 to 128-6, 128-7 to 128-9, 128-10 to 128-12, and 128-13 to 128-15 sequentially control the suction pressures of the regions A₂₁ , A₂₂, and A₂₃, the regions A₃₁, A₃₂, and A₃₃, the regions A₄₁, A₄₂, and A₄₃ and the regions A₅₁, A₅₂, and A₅₃.

In this way, the suction pressure at the reading position P_{R} is made smaller in a region where the amount of ink to be applied to the paper 1 is smaller. Additionally, the timing of when the suction pressure is made smaller may be made early in a region where the amount of ink is smaller. For example, in regions where the amount of ink is relatively large, the suction pressure is made gradually small 80 microseconds after the falling of the PageSync signal is input, and in regions where the amount of ink is relatively small, the suction pressure may be made gradually small 40 microseconds after the falling of the PageSync signal is input.

Next, the in-line sensor 62 reads the image for final printing printed on the paper 1 at the reading position P_{R} through the control of the reading controller 78, and converts the image into read image data (Step S17). Here, since the suction pressure becomes small according to the amount of ink, the influence of the read image data caused by the pattern of the ceramic jacket 108 is eliminated.

Finally, a defect of the image printed on the paper 1 is detected on the basis of the read image data of the in-line sensor 62 and the image data for final printing of the storage unit 80 (Step S18), and the processing of a final flowchart is ended. For example, a defect of an image is detected by calculating a difference image between the read image data and the image data for final printing and analyzing the difference image.

The same control is also performed regarding the transport on the B surface side.

In this way, since the paper 1 is suctioned and transported with a suction pressure of 20 kPa, the paper 1 can be stably transported, and the final printing image can be appropriately printed. Additionally, by lowering the suction force per unit area according to the amount of ink at least at the reading timing of the reading unit 60, the influence caused by the pattern of the ceramic jacket 108 can be eliminated, the image recorded on the paper 1 can be appropriately read, and the reading and the correction performance during test chart printing can be ensured. Hence, the pattern of the ceramic jacket 108 can be optimized for the transportability of the paper 1, and the transport performance, and the reading and the correction performance can be made compatible with each other.

### Third Embodiment

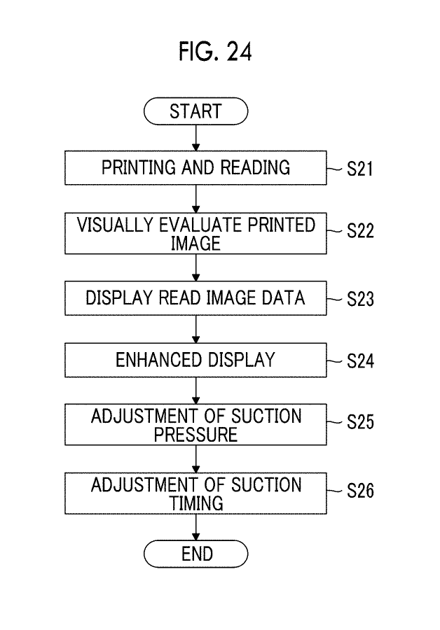

FIG. 24 is a flowchart illustrating steps of a printing method related to a third embodiment. In the present embodiment, a user corrects suction pressures and/or the change timings of the suction pressures in the ink jet printing apparatus 12.

Printing and reading of image data are performed similar to the second embodiment (Step S21).

Next, the user visually evaluates the image printed on the paper 1 in Step S21 (Step S22).

Here, the user displays read image data on the user interface 82 in a case where the unevenness (appears in full width at an equal pitch) considered to be a pattern of the ceramic jacket 108 is viewed (Step S23).

Moreover, the user adjusts at least one of contrast, a maximum value, or a minimum value by the user interface 82 with respect to the displayed read image data, and displays the read image data in an enhanced manner (Step S24). For example, the read image data displayed in 8 bits (0 to 255) is displayed as grayscale values of 0 to 50.

Then, the user compares the image that is displayed in an enhanced manner with the image for final printing of the paper 1, and confirms whether or not the unevenness actually corresponds to the reflection of the pattern of the ceramic jacket 108. If the unevenness corresponds to the reflection, adjustment of the suction pressures and/or the suction timings is performed (Step S25, Step S26).

The adjustment of the suction pressures is carried out by displaying a two-dimensional array of the suction pressures illustrated in FIG. 23 on the user interface 82 (an example of a display unit) and by a user changing corresponding positions with the user interface 82 (an example of an adjustment unit). If it is assumed that unevenness has occurred at a lower right portion of the paper 1 in an example illustrated in FIG. 23, the suction pressures in the regions A₄₃ and A₅₃ are changed from 20 kPa to 15 kPa.

Additionally, as for the adjustment of the suction timings, about four levels of slightly late, standard, slightly early, and early are selectively displayed in advance on the user interface 82 so that the user can appropriately change the levels. In a case where unevenness of a pattern of the ceramic jacket 108 has occurred, the occurrence of the unevenness can be reduced by advancing the timing of when the suction pressures are made small. Additionally, in a case where jamming has occurred, the timing of when the suction pressure is made small may be delayed.

The adjustment of these suction timings is similarly reflected on the B surface side.

In this way, in a case where the user visually evaluates the printed image and there is reflection of the pattern of the ceramic jacket 108, the influence by the pattern of the ceramic jacket 108 can be appropriately eliminated from the read image data by performing the adjustment of the suction pressures and/or suction timings.

### Fourth Embodiment

Although the transport unit 30 has been described up to now by using an example in which the transport drum 100 holding the paper 1 is provided on the transport surface 102, the transport unit 30 is not limited to the drum transport, and for example, belt transport or the like may be used.

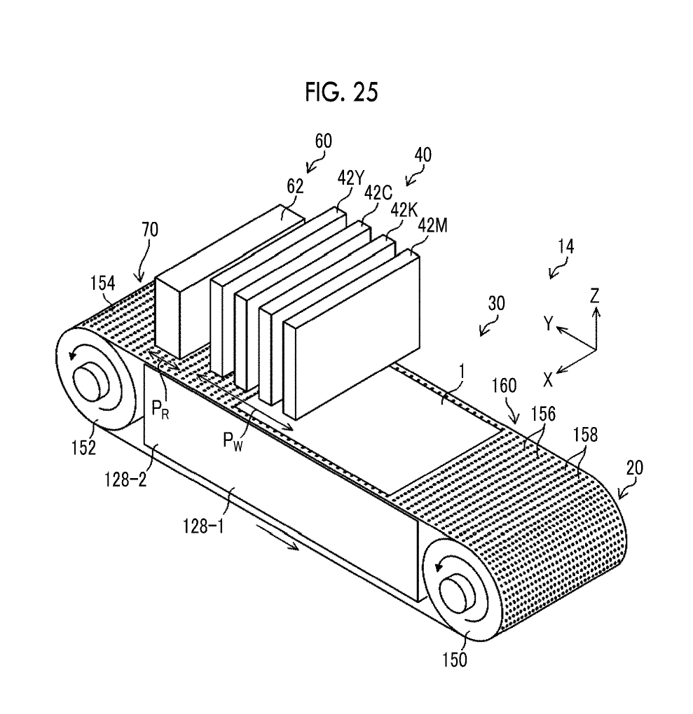

FIG. 25 is a schematic view illustrating an overall configuration of an ink jet printing apparatus 14 related to a fourth embodiment. As illustrated in this drawing, the ink jet printing apparatus 14 is a single path type line printer that prints an image on the recording surface of the paper 1, and includes the paper feed unit 20, the transport unit 30, the printing unit 40, the reading unit 60, the paper ejection unit 70, and the like.

The transport unit 30 has a structure in which an endless transport belt 154 is wound between a roller 150 and a roller 152. The transport belt 154 is formed of rubber and/or urethane. Additionally, the transport belt 154 has a width in the X direction larger than the width of the paper 1 in the X direction, and an outer peripheral surface becomes a transport surface 160. The transport surface 160 is configured so as to form a horizontal plane at the printing position P_{W} that is a position that faces the printing unit 40 and at the reading position P_{R} that is a position that faces the reading unit 60.

The transport unit 30 transports the paper 1 held on the transport surface 160 of the transport belt 154 to the printing unit 40 and the reading unit 60 in this order by transmitting the power of a motor (not illustrated) to at least one of the roller 150 or the roller 152.

The suction mechanisms 128-1 to 128-2 are provided inside the transport belt 154 in the transport unit 30. Additionally, a large number of suction holes 156 passes through the transport belt 154, and projections 158 are formed on the transport surface 160 side of a portion where the suction holes 156 are not formed. By vacuuming the gas in the suction holes 156 of the transport belt 154 using the suction mechanisms 128 to 128-2, and bringing the suction holes into a negative pressure, the paper 1 has the opposite surface of the recording surface suctioned on and held by the transport surface 160.

The printing unit 40 includes the four ink jet heads 42M, 42K, 42C, and 42Y. The ink jet heads 42M, 42K, 42C, and 42Y are respectively disposed sequentially from an upstream side at regular intervals along the transport path of the paper 1 on the transport belt 154. The configuration of the ink jet heads 42M, 42K, 42C, and 42Y is the same as that of the first embodiment. The ink jet heads 42M, 42K, 42C, and 42Y discharge ink from the respective nozzles 48 to the recording surface of the paper 1 transported to the printing position P_{W}, and print an image on the recording surface of the paper 1.

The reading unit 60 is disposed on a downstream side of the printing unit 40 on the transport path of the transport belt 154. The reading unit 60 includes the in-line sensor 62. The configuration of the in-line sensor 62 is also the same as that of the first embodiment. The in-line sensor 62 reads the recording surface of the paper 1 transported to the reading position P_{R}, and converts the read results into read image data.

In addition, the distance in a Y direction between the printing unit 40 and the reading unit 60 is shorter than the length of the paper 1 in the Y direction. Hence, the paper 1 during transport may straddle both of the printing position P_{W} and the reading position P_{R}.

In the ink jet printing apparatus 14 configured in this way, the suction mechanism 128-1 suctions the paper 1 at the printing position P_{W} and the suction mechanism 128-2 suctions the paper 1 at the reading position P_{R}. Additionally, the suction pressures of both the suction mechanism 128-1 and the suction mechanism 128-2 are set to 20 kPa that is the first suction pressure in a case where an image for final printing is printed, and the suction pressure of the suction mechanism 128-1 is set to 20 kPa that is the first suction pressure and the suction pressure of the suction mechanism 128-2 is set to 10 kPa that is the second suction pressure in a case where a test chart is printed. Accordingly, the influence caused by the pattern consisting of the suction holes 156 and the projections 158 of the transport belt 154 is eliminated from the read image data acquired by the in-line sensor 62.

Hence, the pattern of the ceramic jacket 108 can be optimized for the transportability of the paper 1, and the transport performance, and the reading and the correction performance can be made compatible with each other.

### <Others>

Here, although description has been made herein using an example in which the paper 1 is suctioned on the supporting surface by the negative-pressure suction using the vacuum pump 126, an aspect including a charging unit that charges the supporting surface and attracts the paper 1 with an electrostatic force is also possible. For example, a well-known electrostatic drum can be used.

Additionally, although description has been made using an example in which the suction holes that are concave shapes and the projections that are convex shapes are provided on the transport surface, at least one shape of a plurality of concave shapes or a plurality of convex shapes may be provided on the transport surface.

The technical scope of the invention is not limited to the range described in the above embodiments. The components in the respective embodiments can be appropriately combined together between the respective embodiments without departing from the scope of the invention.

### EXPLANATION OF REFERENCES

1: paper

10, 12, 14: ink jet printing apparatus

20: paper feed unit

30: transport unit

40: printing unit

42M, 42K, 42C, 42Y: ink jet head

44M, 44K, 44C, 44Y: nozzle surface

46-1 to 46-17: head module

48: nozzle

48S: piezoelectric actuator

50: head module supporting member

52: head supporting member

60: reading unit

62: in-line sensor

62S: photoelectric conversion element

70: paper ejection unit

72: CPU

74: transport controller

76: printing controller

78: reading controller

80: storage unit

82: user interface

82D: display unit

82I: input unit

84: image processing unit

86: image analysis unit

88: sensitivity correction unit

90: non-discharge correction unit

92: density correction unit

94: ink amount calculation unit

96: suction pressure determination unit

98: defect detection unit

100: transport drum

102: transport surface

104: rotary shaft

106: gripper

108: ceramic jacket

108A: suction hole layer

108B: flow passage groove formation layer

110: suction hole

112: drum suction groove

114: main drum body

116: drum suction hole

118: projection

120: jacket suction groove

122: rotary encoder

124: signal generation unit

126: vacuum pump

128-1 to 128-30: suction mechanism

150: roller

152: roller

154: transport belt

156: suction hole

158: projection

160: transport surface

A₁ to A₅: region

A₁₁ to A₁₃: region

A₂₁ to A₂₃: region

A₃₁ to A₃₃: region

A₄₁ to A₄₃: region

A₅₁ to A₅₃: region

B₁ to B₅: region

P: paper

P₁ to P₃: region

P_{R}: reading position

P_{W}: printing position

S1 to S5: steps of printing method

S11 to S18: steps of printing method

S21 to S26: steps of the printing method

What is claimed is:

1. A printing apparatus comprising:
a supporting part that brings an opposite surface of a recording surface of a recording medium into contact with a supporting surface having shapes of at least one of a plurality of concave shapes or a plurality of convex shapes to support the recording surface;
a suction unit that suctions the recording medium supported by the supporting part with a first suction force per unit area on the supporting surface;
a transport unit that transports the recording medium suctioned on the supporting surface along a transport path;
a printing unit that is disposed to face the transport path, prints an image based on input data on the recording surface at a printing position of the transport path;
a reading unit that is disposed to face the transport path on a downstream side of the transport path with respect to the printing unit, and reads the recording surface at a reading position of the transport path;
a correction unit that corrects at least one of the printing unit or the reading unit on the basis of a reading result of the reading unit; and
a controller that controls a suction force per unit area of the suction unit at the reading position and that suctions the recording medium on the suction unit with a second suction force per unit area smaller than the first suction force per unit area or stops suction of the suction unit, at least in a case where the reading unit reads an image using a reading result in the correction unit.

2. The printing apparatus according to claim 1,
wherein the printing unit includes
an ink jet head that applies ink to print an image on the recording surface of the recording medium, and
a defect detection unit that detects a defect of the image on the basis of the reading result of the reading unit,
wherein the controller makes the suction force per unit area of the suction unit at the reading position smaller in a region where the amount of ink to be applied to the recording surface is smaller, in a case where the reading unit reads the image using the reading result in the defect detection unit.

3. The printing apparatus according to claim 2,
wherein the controller makes the suction force at the reading position smaller by advancing a timing of when the suction force per unit area of the suction unit is made smaller as the amount of ink of the printed image becomes smaller.

4. The printing apparatus according to claim 1,
wherein the supporting surface has a plurality of regions split in a direction orthogonal to a transport direction of the recording medium, and
wherein the controller controls the suction force per unit area of the suction unit in each of the plurality of regions.

5. The printing apparatus according to claim 1,
wherein the supporting surface has a plurality of regions split in a transport direction of the recording medium and a direction orthogonal to the transport direction, and
wherein the controller controls the suction force per unit area of the suction unit in each of the plurality of regions.

6. The printing apparatus according to claim 1, further comprising:
a display unit that displays the reading result of the reading unit in an enhanced manner; and
an adjustment unit that allows a user to adjust at least one of the suction force per unit area of the suction unit at the reading position or a timing of when the suction force is made small.

7. The printing apparatus according to claim 1,
wherein the suction unit includes a vacuuming unit that vacuums gas from a suction hole formed in the supporting surface to suction the recording medium.

8. The printing apparatus according to claim 1,
wherein the transport unit includes a transport drum that rotates the recording medium suctioned on an outer peripheral surface to be transported along the transport path.

9. The printing apparatus according to claim 8,
wherein the supporting surface includes a jacket having shapes of at least one of the plurality of concave shapes or the plurality of convex shapes.

10. The printing apparatus according to claim 1,
wherein the reading unit includes a plurality of photoelectric conversion elements, and
wherein the correction unit corrects sensitivity of the plurality of photoelectric conversion elements on the basis of the reading result of the reading unit.

11. The printing apparatus according to claim 1,
wherein the printing unit prints an image by a plurality of recording elements, and
wherein the correction unit corrects input data corresponding to the recording elements on the basis of the reading result of the reading unit.

12. The printing apparatus according to claim 1,
wherein the printing unit prints an image by a plurality of recording elements, and
wherein the correction unit corrects drive conditions of the plurality of recording elements on the basis of the reading result of the reading unit.

13. A printing method comprising:
a suction step of bringing an opposite surface of a recording surface of a recording medium into contact with a supporting surface having shapes of at least one of a plurality of concave shapes or a plurality of convex shapes to support the recording surface and suctioning the supported recording medium with a first suction force per unit area on the supporting surface;
a transport step of transporting the recording medium suctioned on the supporting surface along a transport path;
a printing step of printing an image based on input data on the recording surface at a printing position of the transport path by a printing unit disposed to face the transport path;
a reading step of reading the recording surface at a reading position of the transport path by a reading unit disposed to face the transport path on a downstream side of the transport path with respect to the printing unit;
a correction step of correcting at least one of the printing unit or the reading unit on the basis of a reading result of the reading step; and
a control step of controlling a suction force per unit area of the suction step at the reading position and suctioning the recording medium in the suction step with a second suction force per unit area smaller than the first suction force per unit area or stopping suction of the suction step, at least in a case where the reading unit reads an image using a reading result in the correction step is read in the reading step.
